(19) United States
(12) Patent Application Publication
(10) Pub. No.: US 2012/0023217 A1
(43) Pub. Date: Jan. 26, 2012

(54) METHOD AND APPARATUS FOR POLICY ENFORCEMENT USING A TAG

(76) Inventor: Shaun Kazuo Wakumoto, Roseville, CA (US)

(21) Appl. No.: 13/260,151

(22) PCT Filed: May 15, 2009
(86) PCT No.: PCT/US09/44194

§ 371 Date: Sep. 23, 2011

(51) Int. Cl. H04L 12/56; G06F 15/173

(52) U.S. Cl. 709/223

(57) ABSTRACT

A method and apparatus for policy enforcement at a network device of a network are disclosed. A packet is received at the network device. A tag associated with the packet is determined. The tag includes a field that indicates a path thru the network that is assigned to the packet. The path is between an entry network device of the packet and a destination network device of the packet. The tag is mapped to a policy of a plurality of policies based on information about a client device. The client information is not available within the packet. One or more rules associated with the policy are determined and enforced.

### BACKGROUND

It is common in conventional computing environments to connect a plurality of computing systems and devices through a communication medium often referred to as a network. Network communication media and protocols may be packet oriented whereby information that is to be exchanged over the network is broken into discrete sized packets of information.

In general, each packet includes embedded control and addressing information that identifies the source device which originated the transmission of the packet and which identifies the destination device to which the packet is transmitted. Source and destination devices are identified by addresses associated with the device. An address is an identifier which is unique within the particular computing network or sub-network.

At the lowest level of network communication, an address is often referred to as a Media ACcess (MAC) address. Network protocols operable above this lowest level of communication may use other addresses for other purposes in the higher-level communication techniques.

In conventional network computing environments, a number of devices are used in addition to interconnected computing systems to efficiently transfer data over the network. Routers and switches are in general network devices which segregate information flows over various segments of a computer network. A segment, as used herein, is any subset of the network computing environment including devices and their respective interconnecting communication links.

A switch device is a device that filters out packets on the network destined for devices outside a defined subset (segment) and forwards information directed between computing devices on different segments of a networked computing environment. Once address locations are learned by a switch, the filtering and forwarding of such information is based on configuration information within the switch that describes how data packets are to be filtered and forwarded, for example, based on source and/or destination address information.

Switches and routers may also be employed to enforce policies. One way to apply policies is based on packet headers. For every switch that will enforce a policy, the switch typically parses multiple portions of the packet header before determining which policy to apply. Most switches parse layer 2, 3, and, 4 packet headers. The burden on the switch to process header information can cause delays on the switch and can lead to performance degradation by the network, especially where many switches are involved in enforcing the policy.

Policy enforcement in communication networks is generally limited to the information about the client or host that is contained within the packet itself. Enforcement typically involves associating a MAC address of a source device, which is located in the packet header, with a policy rule. Using these methods, potentially useful information about the client or host that is not found in the packet is not considered for policy enforcement. Furthermore, where the direct association of the MAC address and the policy is implemented using a table, a separate entry in the table may be needed for each unique MAC address. For large-scale communication networks, the size of such a table may be large and may cause significant delays at the switch or router, for example during execution of a took-up function.

### BRIEF DESCRIPTION OF THE DRAWINGS

FIG. 1 is a block diagram of a mesh network in accordance with an embodiment of the invention.

FIG. 2 is a simplified high-level block diagram of a packet and an entry network device used for policy enforcement in accordance with an embodiment of the invention.

FIG. 3 is a simplified high-level block diagram of a packet and an intermediate network device used for policy enforcement in accordance with an embodiment of the invention.

FIG. 4 is a diagram of a tag in accordance with an embodiment of the invention.

FIG. 5A is a simplified flow diagram depicting a method of policy enforcement in accordance with an embodiment of the invention.

FIG. 5B is a simplified flow diagram depicting policy-based control of a network device in accordance with an embodiment of the invention.

FIG. 6 is a diagram of a Classification table in accordance with an embodiment of the invention.

FIG. 7 is a block diagram of a mesh network implementing a bandwidth reservation policy in accordance with an embodiment of the invention.

FIG. 8 is a block diagram of an exemplary packet switch in accordance with an embodiment of the invention.

### DETAILED DESCRIPTION

Network devices and protocols associated therewith may be used to manage redundant paths between network devices. Where there is but a single path connecting two network devices, that single path, including all intermediate devices between the source and destination devices, represent a single point of failure in network communications between that source and destination device. Redundant paths can be used to enhance reliability of the network. Multiple paths between two devices enhance reliability of network communication between the devices by allowing for a redundant (backup) network path to be used between two devices when a first path fails. A mesh is a network which provides use of the redundant paths even in the presence of path loops.

Efficient policy enforcement at a network device of a mesh network may include using a tag to represent a policy. The tag may be mapped to a policy based on information about a client device that is not available within the packet. Network devices may apply the policy by referring to the tag to determine the associated policy rules.

A. Mesh Network and Tagging

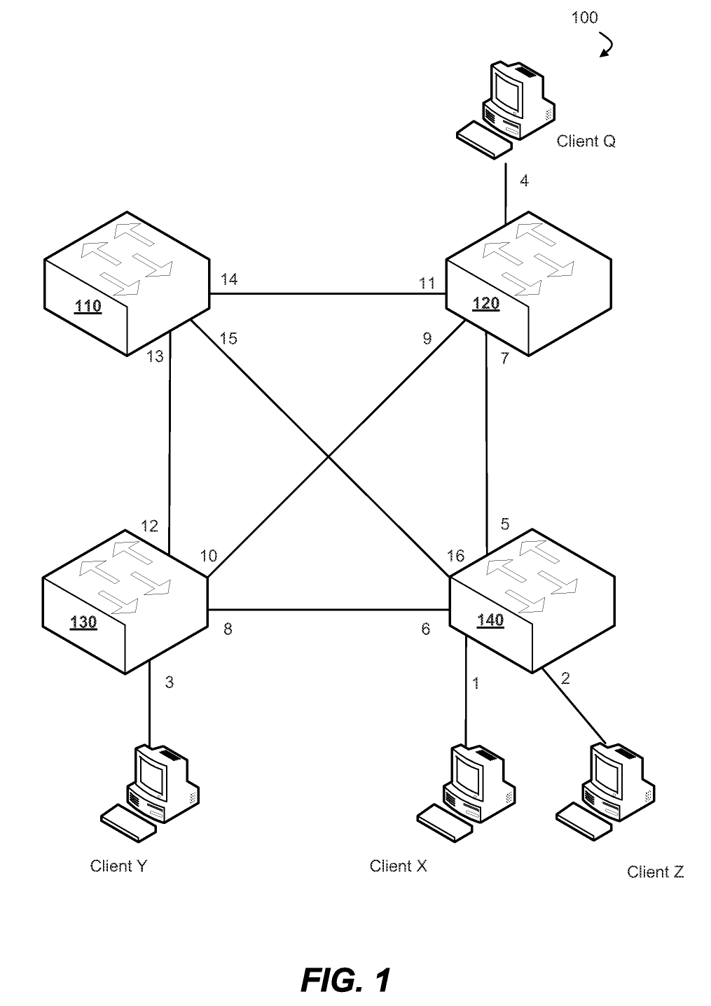

FIG. 1 is a block diagram of a mesh network 100 in accordance with an embodiment of the invention. Mesh network 100 includes mesh switch 110, mesh switch 120, mesh switch 130, and mesh switch 140. Client device is operatively coupled to switch 120. Client devices X and Z are operatively coupled to switch 140. Client device Y is operatively coupled to switch 130. A client device is an originating source of the packet. As shown, mesh network 100 is employed as a full mesh topology where each of switches 110-140 is connected directly to each other. In another embodiment, mesh network 100 may be implemented in a partial mesh arrangement.

Switches 110-140 are configured to analyze and filter packets. Switches 120, 130, and 140 are further configured to insert, remove, and analyze tags within the packets. When a packet is received by a non-mesh port of a switch in the mesh network 100, the switch analyzes the received packet and assigns a tag to the packet. The switch then inserts the tag into the packet and forwards the packet out of the port corresponding to that tag value. As used herein, a non-mesh port is a port that does not connect to another mesh switch. For example, ports 1, 2, 3, and 4 are all non-mesh ports.

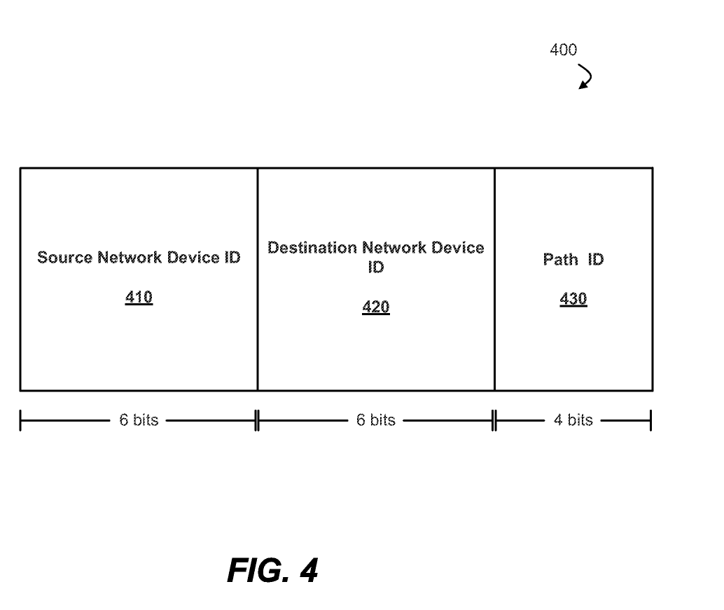

In accordance with an embodiment of the invention, the tag is used to advantageously identify paths within the mesh from a source/entry switch to a destination switch. The tag is associated with the packet and includes a field which indicates a path thru the network assigned to the packet. In one implementation, each source/destination pair may be configured with up to fifteen different paths. In one implementation, four bits are used for the path identifier in a tag and the zero value is considered invalid in this specific implementation. One example of a tag having four bits for the path identifier is described further below in relation to FIG. 4. Other embodiments may provide a different number of paths per switch by using a different number of bits for the path identifier. For example, if the path identifier has six bits, then each source/destination pair may be configured with sixty-three different paths.

The tag may also be used for enforcement of network operation policies. Policy control using the tag provides administrative control of network capabilities to meet, for example, service objectives. Switches 110-140 are further configured to use the tag to enforce various network operation policies associated with the tag. Policies may include access control lists (ACL), Quality-of-service (QoS), including device and application port priorities, rate limiting, network determination, and others policies using configurable rules.

In one embodiment, the tags are generated based on information about the client or host device. As used herein, client information is information about the client or host (i.e., point of origin of the packet) which is ascertainable by an entry network device and is not available within the packet itself. Client information may include data identifying the input port of the network device upon which the packet entered the network, identity data such as login credentials of a user of the client device, user-level access data, password from a capture portal, and other information about the client or host which is ascertainable by an entry network device and is not available within the packet itself. Since the tag is generated using client information, it can be said that the tag identifies a type of user. An entry network device is a network device, such as a switch or router, which is a point of entry of a packet into a particular mesh network.

For example, mesh switch 120 is an entry network device for client Q traffic, mesh switch 130 is an entry network device for client Y traffic, mesh switch 140 is an entry network device for client X traffic and client Z traffic.

Client-based tag determination refers to the process of generating a tag using client information and/or content within the packet (i.e., Ethernet/IP/UDP headers, payload data, etc.). For example, client Y may have provided login credentials to entry switch 130. Entry switch 130 may ascertain the login credentials for client Y, for example, as specified in IEEE 802.11x. In this embodiment, the login credentials are directly ascertainable by the entry switch and are not available within the packet header or payload, per standard packet requirements. Typically, subsequent switches would not be able to ascertain the client information. The entry switch may generate a tag based on the client information and/or content within the packet. The tag will be used for forwarding the packet along the mesh and for policy enforcement. As such, subsequent switches in the mesh which receive the packet can use the tag to indirectly ascertain the client information which was previously known to just the entry switch. In other words, policy enforcement may be based on client information even at subsequent switches in the mesh.

In another embodiment, simple tag determination is used. Simple tag determination refers to the process of generating tags using content from within the packet headers and/or payload.

Entry switches in mesh network 100 may also classify packets to a policy based on the client information and/or the content within the packet itself, such as an Ethernet header, IP header, TCP/UDP headers, etc. The client information may be determined by analyzing the tag. Alternatively, the client information may be ascertained from the entry switch. The client information and/or content within the packet is analyzed. Based on the analysis, the tag of the packet is associated with the policy that the packet is classified under. The policy is made up of one or more rules and switches 110-140 may enforce those policy rules.

B. Architecture to Support Tagging in a Mesh Network

Various software and hardware components may be included to support policy enforcement using a tag in the mesh network.

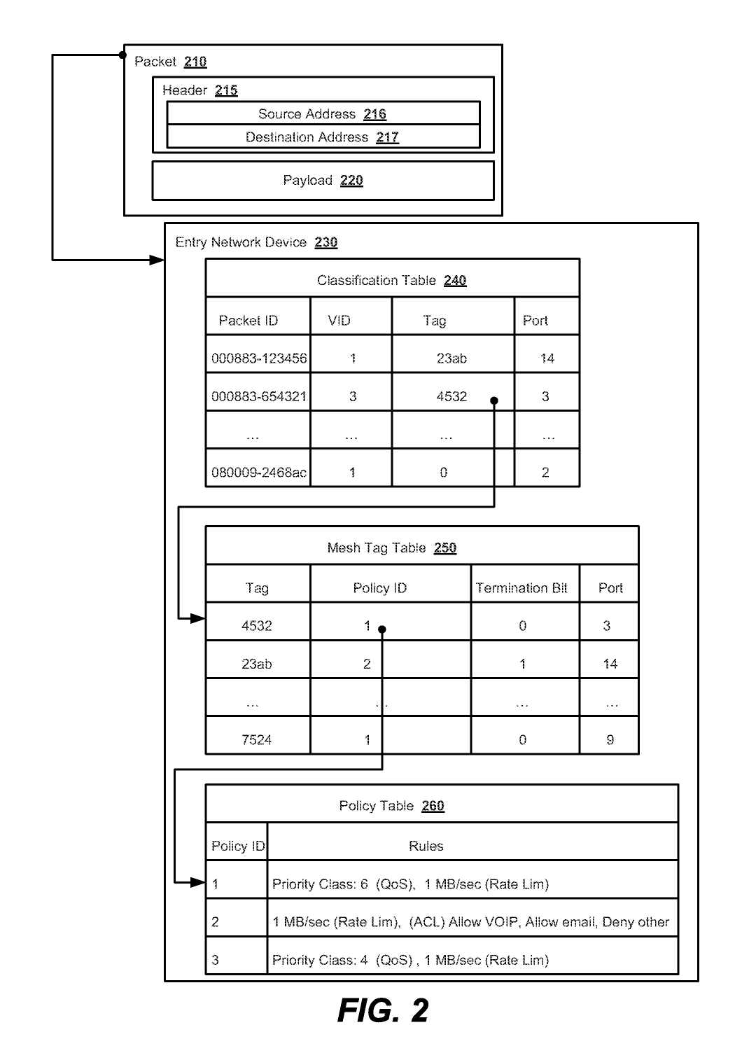

FIG. 2 is a simplified high-level block diagram of a packet 210 and an entry network device 230 used for policy enforcement in accordance with an embodiment of the invention. Packet 210 is a network packet including a header 215 and payload 220. Header 215 includes a source address 216 and a destination address 217. In one embodiment, source address 216 and destination address 217 are Media ACcess (MAC) addresses of the source device and destination device.

Entry network device 230 is a network device, such as a switch or router, which is a point of entry of packet 210 into a mesh network. Entry network device 230 is configured to insert, remove, and analyze tags within received packets. Entry network device 230 includes a Classification table 240, a Mesh Tag table 250, and a Policy table 260.

Each entry network device in the mesh network includes a classification table with a tag field. Classification table 240 is configured to map a packet identifier (packet ID) to a tag value. The packet ID may include content from the packet such as content from an Ethernet/IP/UDP/TCP header or payload data. As shown, the packet ID field is a MAC address (i.e., source/destination MAC address).

The tag field identifies a path to be taken by the incoming packet through the mesh network. Each packet ID in the classification tables is associated with a tag value. For example, Classification table 240 has fields including packet ID, VID, tag, and port. As shown, each packet ID in Classification table 240 is associated with a tag.

A tag with a value of zero may indicate that the destination MAC address is located on a non-mesh port. For example, two client devices may each be connected to a separate non-mesh port of a switch. Referring to FIG. 1, client X and client Y are connected to mesh switch 140 via non-mesh ports 1 and 2, respectfully. If the source of a packet is one of these client devices and the destination is the other of the client devices, the packet will not enter the mesh. The switch assigns a tag value of zero and routes the packet through the non-mesh port that is associated with the destination device. The port field may not be needed if there is a valid tag in the tag field.

A Mesh Tag table 250 is also included in entry network device 230. Mesh Tag table 250 is configured to map a tag value to a policy identifier (policy ID). In one embodiment, the fields of Mesh Tag table include a Tag, a policy ID, a termination bit, and a port field. The policy ID may be an index value which identifies the policy that is to be enforced by the network device. The termination bit indicates whether the path of the tag terminates on the local network device. This advantageously allows the network device to quickly determine that it has to strip out the tag and forward the packet outside of the mesh network. For example, referring to FIG. 1, mesh switch 120 receives a packet that is destined for client Q. Mesh switch 120 may strip out the tag before forwarding the packet to client Q. In alternative embodiments, a look-up function may be used to determine whether the path of the tag terminates on the local network device.

The port field specifies the port in the local network device from which the packet is forwarded. In one embodiment, the values in the port field of Mesh Tag table 250 mirror the values in the port field of Classification table 240. In other words, the tag and port associations are maintained in Classification table 240 and Mesh Tag table 250. For example, a tag value of 4532 is associated with port 3 in both Classification table 240 and Mesh Tag table 250, in alternative embodiments, the port associations may differ between the tables.

A Policy table 260 is included in entry network device 230. Policy table 260 is configured to map a policy II) to a set of configurable rules which, when enforced, carry out a policy. On one embodiment, the rules may be configured according to a default set of rules or a user-configured set of rules. For example, the policies may be set by network administrators via a user interface.

In general, a policy provides one or more rules each of the form: IF <condition> THEN <action>, or an <action> itself. Policy-based networking is one of a number of mechanisms that can be used in achieving control and flow objectives. Policies may be used to identify relevant measurements available through the network and trigger appropriate actions. Since packets are classified based on the information of the client, the policies can be said to be enforced based on client information.

The set of rules may include one or more rules relating to access control lists (ACL), Quality-of-service (QoS), including device and application port priorities, rate limiting, network determination, and others. For example, the policy may include ACL rules or QoS rules or rate limiting rules or network determination rules or any combination thereof.

Typically, an ACL is applied to a port of a network device. As described herein, the ACE is applied to a client or host. Using the tag, an ACE may be enforced at multiple network devices (including at an edge) along a path in the mesh based on client information. Likewise, QoS policies may be enforced at multiple network devices along the path based on client information using the tag.

Rate limits are typically imposed on a port by port basis. Using the tag, rate limit policies may be enforced at a port based on client information. In one embodiment, aggregate rate limits may be imposed such that all traffic from multiple clients cannot exceed X % of the total available bandwidth for the network device or on a port of the network device. In another embodiment, the aggregate rate limits are enforced on a next-hop network device.

For example, client X, Y, and Z of FIG. 1 are clients communicating with client Q. The packets of client X and Z may follow a path from port 1 of entry network device 140 and port 2 of entry network device 140, respectively, out of port 6 of entry network device 140 to port 8 of network device 130, out of port 10 of network device 130 to port 9 of network device 120. The packets of client Y may follow a path from port 3 of entry network device 130 out of port 10 of entry network device 130 to port 9 of network device 120.

An aggregate rate limit policy may be enforced at the non-mesh and mesh ports. The tags of clients X, Y, and Z all map to the same policy which imposes the aggregate rate limit rules. Specifically, at port 1, network device 140 may impose a rate limit of 10% for the traffic of client X, at port 2, network device 140 may impose a rate limit of 10% for the traffic of client Z, and at port 3, network device 130 may impose a rate limit of 10% for the traffic of client Y. At port 8, network device 130 may impose a rate limit of 10% for the aggregate traffic of clients X and Z. Similarly, at port 9, network device 120 may impose the rate limit of 10% for the aggregate traffic of clients X, Y, and Z.

The tag may also be useful to enforce network operation policies. For example, a network device may use the tag to assign a client's traffic to a VLAN.

Classification table 240, Mesh Tag table 250, and Policy table 260 are used in conjunction with each other to efficiently identify policy rules. When a packet, such as packet 210, is received from on a non-mesh port of entry network device 230, entry network device 230 is configured to associate content within packet 210 (packet ID) with a tag value in the Classification table 240 table. In one embodiment, the content (packet ID) is a destination MAC address. In another embodiment, the content may be a type of traffic, such as voice-over-IP (VOW), web, email, etc. The association may be broadcast to other network devices within the mesh. The Classification tables of the other network devices in the mesh are updated to reflect the association.

Upon entering the mesh network, entry network device 230 inserts the tag value into packet 210 for subsequent reference. The tag value is used to index Mesh Tag table 250 and to identify the associated policy ID. The policy ID is used to index Policy table 260 and to identify the associated rule(s). For example, an entry in Policy table 260 with the policy ID is found.

A policy identifier may be associated with multiple tags in Mesh Tag table 250. For example, the tag value “4532” maps to policy ID “1” and the tag value “7524” also maps to policy ID “1.” The indirection provided by Mesh Tag table 250 and Policy table 260 enables the policy rules to be specified once and referenced many times, without an increase in overhead. For example, in a mesh network with 1000 engineering clients which all classify to a same policy, 1000 entries would be needed in a typical implementation which maps source MAC addresses to policies. Each entry would recite the same policy rules. The use of the tag enables the policy to be recited once.

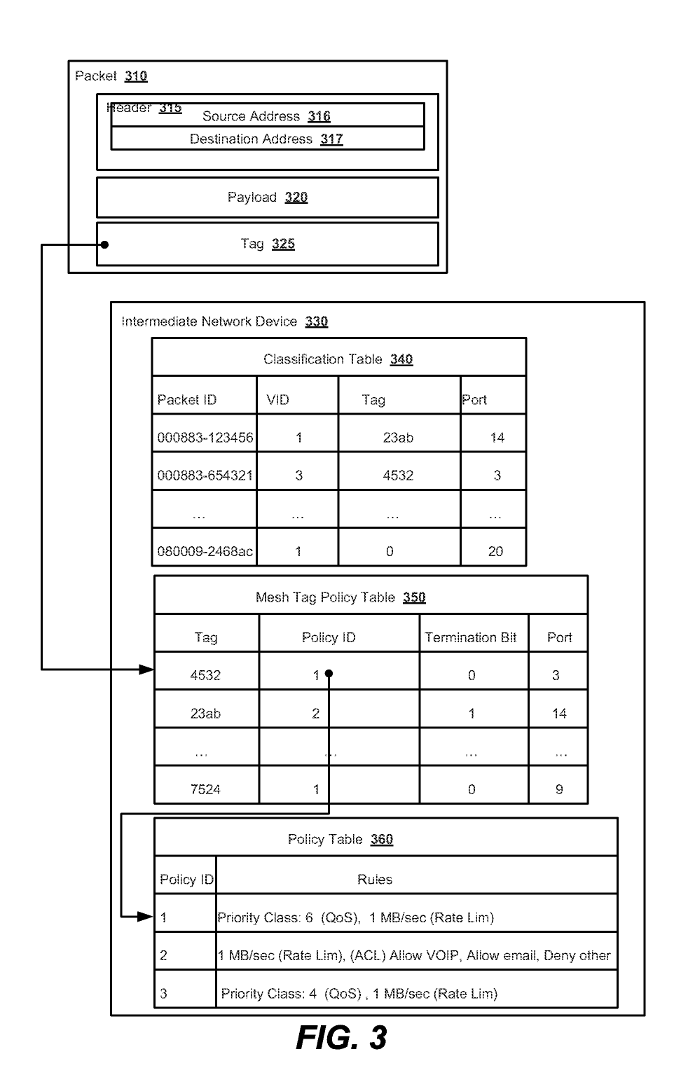

FIG. 3 is a simplified high-level block diagram of a packet and an intermediate network device used for policy enforcement in accordance with an embodiment of the invention. Packet 310 is a network packet including a header 215, payload 220, and tag 325. Packet 310 is different from packet 210 at least in that packet 310 includes tag 325. In one embodiment, tag 325 was inserted by an entry network device.

Intermediate network device 330 is a network device, such as a switch or router, within the mesh network and which is not an entry network device. For example, intermediate network device 330 may be in a downstream path of a packet. Intermediate network device 330 is configured to insert, remove, and analyze tags within received packets. Intermediate network device 330 includes Classification table 340, a Mesh Tag table 350, and a Policy table 360.

Each intermediate network device in the mesh network includes a Classification table with a tag field, such as Classification table 340. The Classification tables of each network device (i.e., entry and intermediate) within the same mesh network are duplicates of each other such that updates to the Classification table of one network device is propagated to the Classification tables of the other network devices. As shown. Classification table 340 is structurally similar to Classification table 240.

A Mesh Tag table 350 is also included in intermediate network device 330. Mesh Tag table 350 is configured to map a tag value to a policy identifier (ID). In one embodiment, the fields of Mesh Tag table include a Tag, a policy ID, a termination bit, and a port field. The Mesh Tag tables of each network device (i.e., entry and intermediate) within the same mesh network are duplicates of each other such that updates to the Mesh Tag table of one network device is propagated to the Mesh Tag tables of the other network devices. As shown, Mesh Tag table 350 is structurally similar to Mesh Tag table 250.

A Policy table 360 is included in intermediate network device 330. Policy table 360 is configured to map a policy ID to a set of configurable rules which, when enforced, carry out a policy. The Policy tables of each network device (i.e., entry and intermediate) within the same mesh network are duplicates of each other such that updates to the Policy table of one network device is propagated to the Policy tables of the other network devices. As shown, Policy table 360 is structurally similar to Policy table 260.

Intermediate network device 330 uses Mesh Tag table 350 and Policy table 360 in conjunction with each other to efficiently identify policy rules. Unlike an entry network device, an intermediate network device is configured to use a tag value from a received packet to index into a mesh tag policy table. When a packet, such as packet 310, is received from a mesh port of intermediate network device 330, intermediate network device 330 uses tag 325 to directly index Mesh Tag Policy table 350. An associated policy ID may be identified using Mesh Tag Policy table 350. The policy ID is used to index Policy table 360 and to identify the associated one or more rules. As such, the use of the tag enables the network devices to quickly and efficiently determine which policy to apply without processing of multiple items in the content of the packet.

FIG. 4 is a diagram of a tag 400 in accordance with an embodiment of the invention. The tag includes a source network device identifier 410, a destination network device identifier 420, and a path identifier 430. In this embodiment, the tag is sixteen bits in length. In particular, the source network device identifier 410 is six bits long, the destination network device identifier 420 is six bits long, and the path identifier 430 is four bits long. The paths identified by path identifier 430 are direct paths and full paths. In this implementation, with the network device identifiers being six bits long, sixty-three different network devices in the mesh may be distinguished and identified. (The value zero for the network device ID being considered an invalid value in this implementation.) With the path identifier being four bits long, fifteen different paths may be identified per source-destination pair. (The value zero for the path id again being considered invalid in this implementation.) Other embodiments may have other lengths for these fields, resulting in different numbers of identifiable network devices and paths.

Consider, for example, the mesh depicted in FIG. 1. Tag 400 of the format depicted in FIG. 4 may be used to identify different paths, for instance, from network device 110 to network device 140. Given that source and destination, each tag would include an identifier corresponding to network device 110 in the source network device identifier field 402 and an identifier corresponding to network device 140 in the destination network device identifier field 404. Distinctive path identifiers, one per path between network device 110 and network device 140, would be included in the path identifier field 406.

For instance, a first path may go directly from network device 110 and network device 140 by exiting portly of network device 110 and entering port 16 of network device 140. A second path may travel from network device 110 and network device 140 via network device 130 by exiting port 13 on network device 110, entering port 12 of network device 130, exiting port 8 of network device 130, and entering port 6 of network device 140. And so on for other possible paths. Each path is associated with a unique path identifier.

Consider the case where network device 140 learns a new MAC address and informs the rest of the mesh of the new MAC address associated with network device 140. Network device 110 can then assign to that MAC address a tag corresponding to one of the aforementioned paths from network device 110 and network device 140. Subsequently, every packet destined for that MAC address that enters network device 110 may be forwarded through the mesh based on that assigned tag. As previously described, the tag may be associated with a packet ID based on content within the packet, such as a MAC address or a type of traffic.

in accordance with an embodiment of the invention, each mesh network device knows the entire mesh topology, for example using a mesh topology inform protocol and other methods.

Tag 400 is used to identify a policy which is to be enforced. Between any one source network device and destination network device, the four bits of path identifier 430 can identify sixteen (2⁴) different policies. Additional bits may be added to the tag to provide for the possibility of more policies. For example, if an additional four bits is added to the tag, 256 (2⁸) potential policies may be identified for traffic between the pair of source-destination network devices.

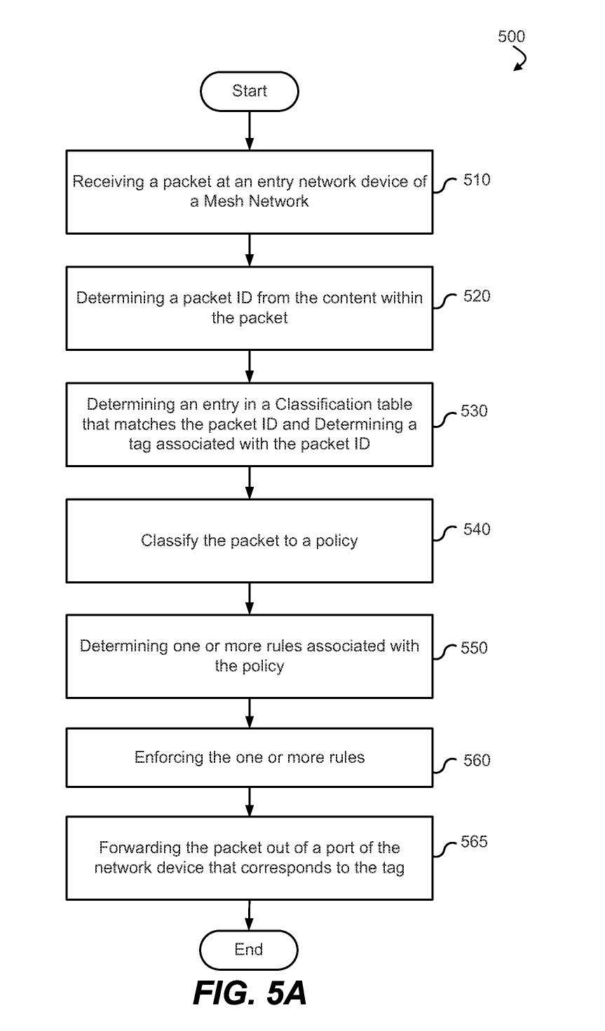

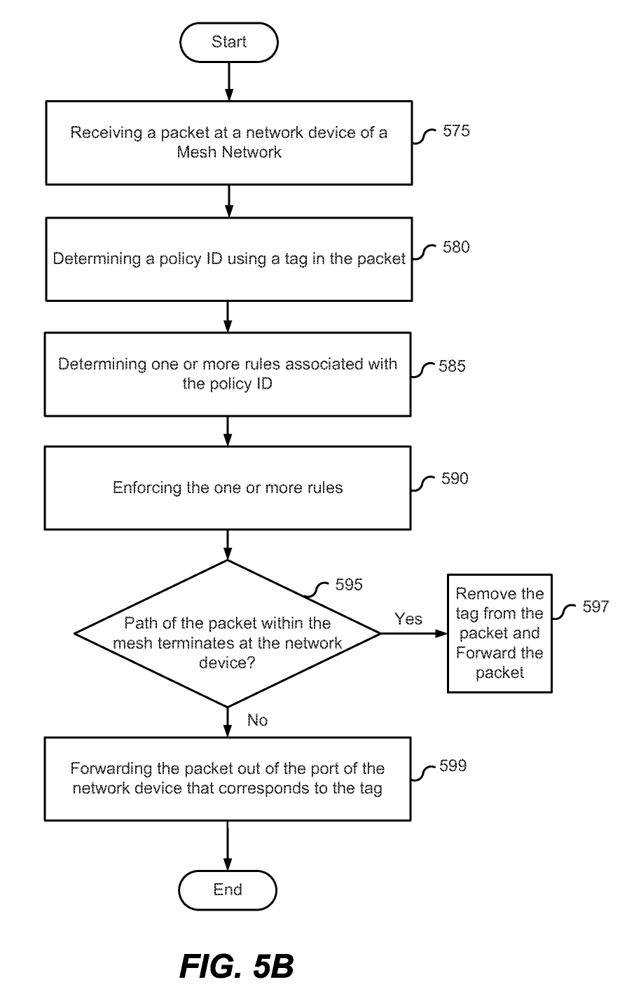

FIG. 5A is a simplified flow diagram depicting a method of policy enforcement in accordance with an embodiment of the invention. As previously described, a policy table maps a policy identifier to a set of configurable rules, which, when enforced, carry out a policy. A policy table may be configured prior to policy enforcement. At step 510, a packet is received at an entry network device of a mesh network. For example, the packet may be received at a non-mesh port of the entry network device.

At step 520, a packet identifier (packet ID) is determined from the content within the packet. The packet ID may be a MAC destination address and/or other content. An entry in a Classification table that matches the packet ID is determined at step 530. For example, the entry network device may look for the packet's MAC destination address and/or other Ethernet/IP/UDP/TCP header or payload data in the Classification table.

As previously described, an entry network device is configured to insert tags within received packets. In one embodiment, a tag associated with the packet ID is also determined at step 530. The tag may be generated in many ways. As previously described, client-based tag determination refers to the process of generating a tag using client information and/or content within the packet (i.e., Ethernet/IP/UDP headers, payload data, etc.). For example, a hash function for IP packets may be used to generate the tag. The hash function may depend on the following packet fields: MAC source address, MAC destination address, IP source address, IP destination address, and login credentials. Other methods of generating a tag value may also be implemented.

At step 540, the packet is classified to a policy. Information about the client is obtained and the packet is classified based on that information. In one embodiment, the policies themselves are preconfigured, for example in the form of a policy table. The entry network device possesses client information (not contained within the packet itself) which enables the entry network device to classify the packet to a policy. Specifically, classification involves mapping the tag to a policy and/or a policy identifier. The policy identifier is used to identify the policy that is to be applied. In one embodiment, the entry network device associates the tag to a policy identifier based on client information such as a type of a client and/or the ingress port of the packet in the entry network device.

In one embodiment, the association may be accomplished based on one or more of the following client information which describe the type of client: login credentials, user-level access, password from a capture portal, and other information about the client or host. Based on the client information, entry network device 130 may associate the tag with a particular policy identifier. In one embodiment, a first policy identifier may include one or more rules targeted to those clients with low security clearance, and another policy identifier may include one or more rules targeted to those clients with high security clearance. It may be advantageous to provide those clients with high security clearance with a high Quality of Service and a high rate limit.

For example, client Y of FIG. 1 may have provided login credentials at an initial firewall. Entry network device 130 may acquire login credentials for example as specified in IEEE 802.11x. The login credentials may indicate that client Y is an engineering user and as such, the tag should be associated with a policy targeted for engineering users. If client Y performs a login in a conference room, the entry network device may use the login credentials to associate policies of the engineering group to the traffic of client Y.

Classification may also be performed using information about the ingress port of the packet. In one embodiment, the ports of the entry network device may be assigned to particular services, clients, or types of clients. For example, port 1 of FIG. 1 may be assigned to client X of a marketing department of an organization and port 2 may be assigned to client Z of an engineering department of the organization. Engineering and marketing users may have different policies applied to their respective network traffic.

Entry network device 140 is able to determine the ingress non-mesh port from which the packet was received based on port assignments. Information about the client device may be determined, for example, based on an assignment of a port to a type of client. Entry network device 140 may associate the tag of the packet with a particular policy identifier. Upon entering the mesh, client X may be assigned tag 0xABC1 and client Z may be assigned a different tag 0xABC2. Even if both clients communicate with the same destination device, such as client Y, each will have different associated tags. Different policies may be associated with the different tags. It may be advantageous to associate tag 0xABC1 (Client X, Marketing) with a policy which places high restrictions on rate limits and to associate tag 0xABC2 (Client Z, Engineering) with a policy which places low restrictions on rate limits and assigns a high Quality-of-Service on the traffic. In one embodiment, network devices are hard-coded with the port assignments (e.g., port 1 is assigned to marketing users, port 2 is assigned to engineering users).

The policy identifiers can be reusable such that multiple associations can be made with one policy. The associations are broadcast to the other network devices within the mesh network.

At step 550, one or more rules associated with the policy are determined. In one embodiment, the policy identifier is associated with a set of one or more rules of the policy. The one or more rules are enforced at step 560. At step 565, the packet is forwarded out of a port of the network device that corresponds to the tag. For example, the corresponding port may be determined by referencing either a Classification table or a Mesh tag table. The packet is forwarded to the next network device in the path identified in the tag.

FIG. 5B is a simplified flow diagram depicting policy-based control of a network device in accordance with an embodiment of the invention. At step 575, a packet is received at a network device of a mesh network. In one embodiment, the network device is an intermediate network device. As previously described, the packet was modified to include a tag. The tag associated with the packet is analyzed and at step 580, a policy identifier (ID) is determined using a tag in the packet. The tag is mapped to a policy ID. The policy ID itself is mapped to one or more rules that make up a policy. At step 585, the one or more rules associated with the policy ID are determined. The one or more rules are enforced at step 590. In one embodiment, the network device is operated based, at least in part, on the policy and policy rules. For example, an ACL may indicate that the network device be operated to allow certain traffic but deny other traffic.

At step 595, it is determined whether the path of the packet within the mesh terminates at the network device. The tag includes a path that the packet travels within the mesh. In one embodiment, if the local network device is the last in the path as indicated in the tag, it is determined that the local network device is the termination point in the mesh. In another embodiment, a termination bit in the packet may indicate that the local network device is the point of termination within the mesh. Other methods of determining whether the packet terminates at the local network device may also be applied.

Upon determining that the path within the mesh terminates at local network device, at step 597, the tag is removed from the packet and the packet is forwarded. In one embodiment, the tag is stripped out of the packet if the packet is forwarded to a node outside of the local mesh.

At step 599, the path of the packet continues within the mesh and the packet is forwarded out of the port of the network device that corresponds to the tag. For example, the corresponding port may be determined by referencing a Mesh tag table. The packet is forwarded to the next network device in the path identified in the tag.

C. Policy Implementations

Traffic-based mesh tagging is a logical extension of the tagging techniques discussed herein.

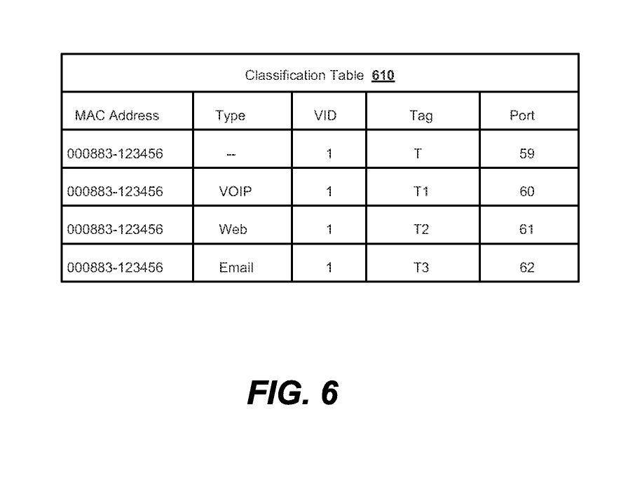

FIG. 6 is a diagram of a Classification table 610 in accordance with an embodiment of the invention. Classification table 610 is configured to map a packet identifier (packet ID) to a tag value and may be used for traffic-based mesh tagging. As shown, Classification table 610 has fields including MAC address, traffic type. VII), tag, and port. In one embodiment, a packet ID made up of a MAC address field and a type field. The type field indicates the packet is of a particular type of traffic. The type information may be determined by analyzing the packet and determining the type of traffic carried by the packet in the header and/or payload. A packet ID may be generated using the content within the packet (i.e., MAC address) and the traffic type. Different tag values may be generated for different traffic types even if the MAC address is the same. The tag identifies a type of client and also identifies the type of traffic generated by the client.

Tagging based on the type of client traffic enables policies to be tailored to the type of traffic. For example, an ACE, may allow VoIP-type traffic and email-type traffic and may deny all other types of traffic. Moreover, tagging based on traffic type allows the assignment of different paths and/or policies based on the traffic. For example, VoIP-type traffic can be given a higher priority path and policy than web-type traffic.

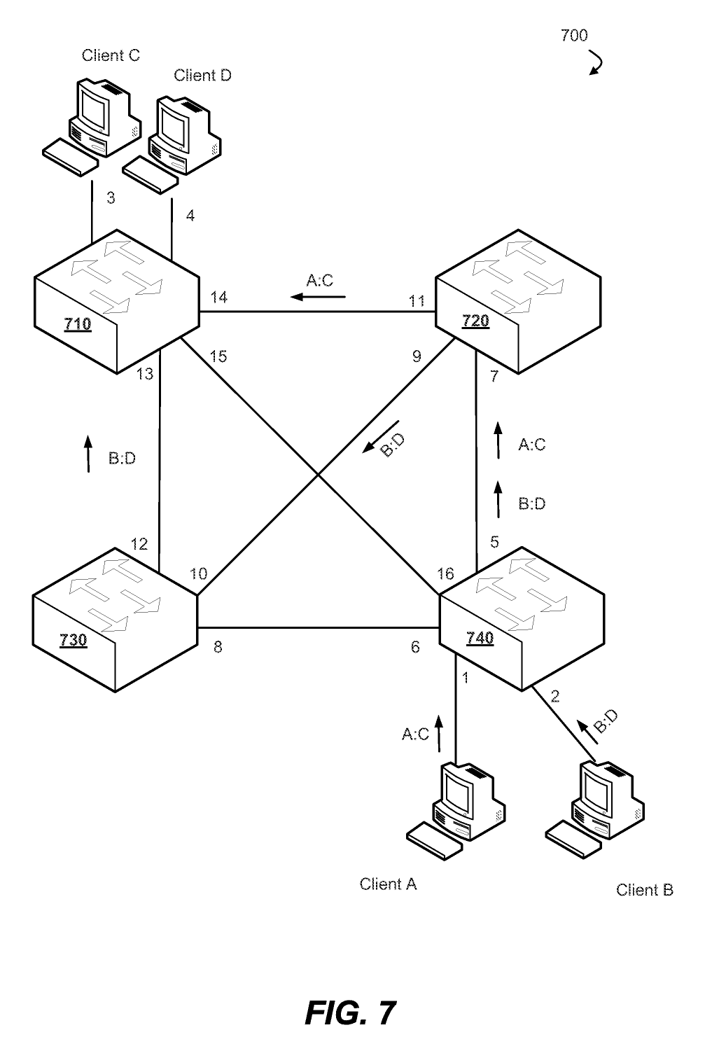

FIG. 7 is a block diagram of a mesh network 700 implementing a bandwidth reservation policy in accordance with an embodiment of the invention. Mesh network 700 includes mesh switch 710, mesh switch 720, mesh switch 730, and mesh switch 740. Client device A and client device B are operatively coupled to switch 740. Client device C and client device D are operatively coupled to switch 710.

As shown, the traffic of client device A to client device C follows a path into port 1 of mesh switch 740, out of port 5 of mesh switch 740 to port 7 of mesh switch 720, out of port 11 of mesh switch 720 to port 14 of mesh switch 710, and finally out of port 3 of mesh switch 710 to the destination, which is client device C. The traffic of client device B to client device D follows a path into port 2 of mesh switch 740, out of port 5 of mesh switch 740 to port 7 of mesh switch 720, out of port 9 of mesh switch 720 to port 10 of mesh switch 730, out of port 12 of mesh switch 730 to port 13 of mesh switch 710, and finally out of port 4 of mesh switch 710 to the destination, which is client device D.

One or more bandwidth reservation policies may be enforced by the ingress/egress ports of the mesh switches 710-740 for the entire path of a packet. In other words, a single port may enforce different bandwidth reservation policies. A bandwidth reservation policy is a policy which guarantees a minimum bandwidth for an end-to-end path in the mesh.

For example, the traffic from client A to client C may be assigned a tag T1 and the traffic from client B to client D may be assigned a tag T2 by entry mesh switch 740. Entry mesh switch 740 generates the tags based on client information, including the input port. Entry mesh switch 740 may determine that traffic from port 1 can be attributed to client A and traffic from port 2 can be attributed to client B. Tag T1 may be associated with a policy that sets a minimum bandwidth of 500 MB, whereas tag T2 may be associated with a policy that sets a minimum bandwidth of 1000 MB.

Ports of mesh network 700 may enforce one or more associated policies by referencing the tag of the packets. For packets associated with tag T1, ports 5, 11, and 3 reserve at least 500 MB. For packets associated with tag T2, ports 5, 9, 12, and 4 reserve at least 1000 MB.

in another embodiment, the traffic of client A to client C may be assigned to various tags, and each of those tags map to the same policy (i.e., minimum bandwidth of 500 MB). Likewise, the traffic of client B to client D may be assigned to various tags, and each of those tags map to the same policy (i.e., minimum bandwidth of 1000 MB). As such, the tags can be used to enforce policies of different bandwidth reservation policies even if traffic originates from the same source switch and is directed to the same destination switch.

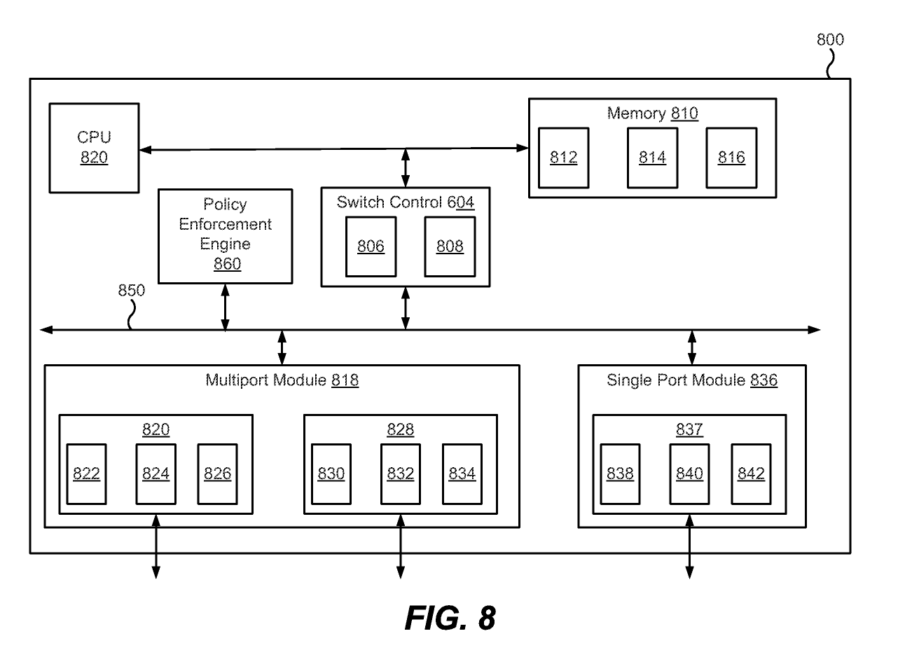

FIG. 8 is a block diagram of an exemplary packet switch 800 in accordance with an embodiment of the invention. The specific configuration of packet switches used may vary depending on the specific implementation. A central processing unit (CPU) 802 performs overall configuration and control of the switch 800 in operation. The CPU 802 operates in cooperation with switch control 804, an application specific integrated circuit (ASIC) designed to assist CPU 802 in performing packet switching at high speeds.

The switch control 804 controls the “forwarding” of received packets to appropriate locations within the switch for further processing and/or for transmission out another switch port. Inbound and outbound high speed FIFOs (806 and 808, respectfully) are included with the switch control 804 for exchanging data over switch bus 852 with port modules. In accordance with an embodiment of the invention, the switch control 804 is an ASIC and is configured to insert, remove, and analyze a tag within a fixed location in a packet. Moreover, switch control 804 may include a policy repository which is configured to store a plurality of policies for enforcement by switch 800.

Memory 810 includes a high and low priority inbound queue (812 and 814, respectively) and outbound queue 816. High priority inbound queue 812 is used to hold received switch control packets awaiting processing by CPU 802 while low priority inbound queue 814 holds other packets awaiting processing by CPU 802. Outbound queue 816 holds packets awaiting transmission to switch bus 850 via switch control 804 through its outbound FIFO 808. CPU 802, switch control 804 and memory 810 exchange information over processor bus 852 largely independent of activity on switch bus 850.

The ports of the switch may be embodied as plug-in modules that connect to switch bus 850. Each such module may be, for example, a multi-port module 818 having a plurality of ports in a single module or may be a single port module 836. A multi-port module provides an aggregate packet switch performance capable of handling a number of slower individual ports. For example, in one embodiment, both the single port module 836 and the multi-port module 818 may be configured to provide, for example, approximately 1 Gbit per second packet switching performance. The single port module 836 therefore can process packet switching on a single port at speeds up to 1 Gbit per second. The multi-port module 818 provides similar aggregate performance but distributes the bandwidth over, (preferably, eight ports each operating at speeds, for example, of up to 100 Mbit per second. These aggregated or trunked ports may be seen as a single logical port to the switch.

Each port includes high speed FIFOs for exchanging data over its respective port. Specifically, each port, 820, 828, and 837, preferably includes an inbound FIFO 822, 830, and 838, respectively for receiving packets from the network medium connected to the port. Further, each port 820, 828, and 837, preferably includes a high priority outbound FIFO 824, 832, and 840, respectively, and a low priority outbound FIFO 826, 834, and 842, respectively. The low priority outbound FIFOs are used to queue data associated with transmission of normal packets while the high priority outbound FIFO is used to queue data associated with transmission of control packets. Each module (818 and 836) includes circuits (not specifically shown to connect its port FIFOs to the switch bus 850.

As packets are received from a port, the packet data is applied to the switch bus 850 in such a manner as to permit monitoring of the packet data by switch control 804. In general, switch control 804 manages access to switch bus 850 by all port modules (i.e., 818 and 836). All port modules “listen” to packets as they are received and applied by a receiving port module to switch bus 850. If the packet is to be forwarded to another port, switch control 804 applies a trailer message to switch bus 850 following the end of the packet to identify which port should accept the received packet for forwarding to its associated network link.

Policy enforcement engine 860 is a hardware element in the switch 800 that manages access and traffic flow policies such as ACL, QoS, rate limiting, and network determination policies. In one embodiment, policy enforcement engine 860 receives an indication by switch control 804 as to which policy to enforce. The identified policy may then be enforced.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optionally or magnetically readable medium such as, for example, a CD, DVD, magnetic disk or magnetic tape. It will be appreciated that the storage devices and storage media are embodiments of machine-readable storage medium that are suitable for storing a program or programs that, when executed, for example a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

By pushing into the hardware, policy enforcement is performed faster than it would take otherwise in a software implementation. In one embodiment, the Classification table, mesh tag table, and policy tables are implemented in hardware, for example, as a repository in switch control 804.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of my method or process so disclosed. The claims should not be construed to cover merely the foregoing embodiments, but also any embodiments which fall within the scope of the claims.

What is claimed is:

1. A method of policy enforcement at a network device of a network, the method comprising:
receiving a packet at the network device of the network;
determining a tag associated with the packet, wherein the tag comprises a field indicating a path assigned to the packet, and wherein the path is thru the network and between an entry network device of the packet and a destination network device of the packet;
mapping the tag to a policy of a plurality of policies based on information about a client device not available within the packet, wherein the client device is an originating source of the packet;
determining one or more rules associated with the policy; and
enforcing the one or more rules.

2. The method of claim 1, wherein the tag is mapped to a policy identifier associated with the policy, and wherein determining the one or more rules comprises
finding an entry in a policy table with the policy identifier; and
determining the one or more rules associated with the policy identifier.

3. The method of claim 1, further comprising:
analyzing the packet;
determining a type of traffic carried by the packet based on the analysis; and
generating a packet identifier using content within the packet and the type of traffic.

4. The method of claim 1, wherein the network device is a point of entry of the packet into the network, further comprising:
determining the information about the client device not available within the packet;
generating the tag using the information about the client device; and
inserting the tag into the packet.

5. The method of claim 1, further comprising:
determining that the path of the packet within the network terminates at the network device;
removing the tag from the packet; and
forwarding the packet out of the port of the network device.

6. The method of claim 1, wherein the packet first enters the network at the network device, and wherein the information about the client is at least one of data identifying the input port of the network device, login credentials of a user of the client device, user-level access data, or a password from a capture portal.

7. The method of claim 1, wherein the policy of the plurality of policies is at least one of an access control list, a Quality-of-service policy, a rate limiting policy, a bandwidth reservation policy, or a network determination policy.

8. A network switch device for use in a network for enforcing policies using a tag, the device comprising:
a plurality of ports;
a switch controller coupled to the plurality of ports, wherein the switch controller is configured to:
receive a packet at the network device of the network;
determine a tag associated with the packet, wherein the tag comprises a field indicating a path assigned to the packet, and wherein the path is thru the network and between an entry network device of the packet and a destination network device of the packet;
map the tag to a policy of a plurality of policies based on information about a client device not available within the packet, wherein the client device is an originating source of the packet;
determine a policy identifier associated with the policy;
determine one or more rules associated with the policy identifier; and
forward the packet out of a port of the network device; and
a policy enforcement engine coupled to the switch controller, the policy enforcement engine configured to enforce the one or more rules.

9. The device of claim 8, further comprising:
a policy repository coupled to the switch controller, the policy repository configured to store the plurality of policies.

10. The device of claim 8, wherein the network switch device is a point of entry of the packet into the network, and wherein the switch controller is further configured to determine the information about the client device based on an assignment of a port to a type of client.

11. The device of claim 8, wherein the switch controller is further configured to generate the tag using the information about the client device.

12. A method for policy-based control of a network device of a network, the method comprising:
receiving a packet at the network device of the network;
analyzing a tag associated with the packet, wherein the tag comprises a field indicating a path thru the network assigned to the packet;
determining a policy of a plurality of policies associated with the packet based on the analysis of the tag;
determining one or more rules of the policy; and
operating the network device based at least in part on the policy.

13. The method of claim 12, wherein the network device is an intermediate network device within the network.

14. The method of claim 12, further comprising:
determining that the path of the packet within the network terminates at the network device;
removing the tag from the packet; and
forwarding the packet out of a port of the network device.

15. The method of claim 12, wherein the policy of the plurality of policies is at least one of an access control list, a Quality-of-service policy, a rate limiting policy, a bandwidth reservation policy, or a network determination policy.
